(19) United States
(12) Patent Application Publication
(10) Pub. No.: US 2008/0009576 A1
(43) Pub. Date: Jan. 10, 2008

(54) PROCESS FOR MANUFACTURING OF THERMOPLASTIC COMPOSITES WITH IMPROVED PROPERTIES

(76) Inventors: Charles W. Alexander, Gap, PA (US); Jayantha Amarasekara, Exton, PA (US); Ann Marie Burnell, Downington, PA (US); Darren Cameron Clark, Pottstown, PA (US)

Correspondence Address: SABIC - LNP-CE 08CE;SABIC Innovative Plastics - IP LEGAL, ONE PLASTICS AVENUE, PITTSFIELD, MA, 01201-3697, US

(21) Appl. No.: 11/770,845

(22) Filed: Jun. 29, 2007

Related U.S. Application Data
(60) Provisional application No. 60/806,273, filed on Jun. 30, 2006.

(51) Int. Cl. B28B 5/00; C08K 3/04; C08K 3/10

(52) U.S. Cl. 524/407; 264/241; 524/406; 524/496; 524/566; 524/568; 524/570; 524/577; 524/579; 524/584; 524/586; 524/599; 524/606

(57) ABSTRACT

A process for forming thermoplastic composite materials that have improved properties wherein the process is an in-line compounding process that feeds a thermoplastic resin and a filler to a compounder to form a thermoplastic composite material that is then injected into a mold to form an article that includes the thermoplastic composite material. Since the thermoplastic composite material is not pelletized or otherwise processed between formation of the thermoplastic composite material and the injection-molded article, less damage and/or degradation of the filler occurs during processing such that the resultant thermoplastic composite material and/or article has improved properties at the same or even at lower filler loadings than prior art materials. In addition, as the thermoplastic composite material is not subjected to ionic and/or airborne contaminates between formation of the thermoplastic composite material and the injection-molded article, the resultant materials and/or articles have less impurities in the final materials and/or articles than those formed in two-step processes.

### CROSS REFERENCE TO RELATED APPLICATIONS

This application claims priority to U.S. Provisional Application Ser. No. 60/806,273 filed on Jun. 30, 2006, which is incorporated herein by reference in its entirety.

### FIELD OF INVENTION

The present invention relates to methods of forming thermoplastic composites and, in particular, to methods of forming thermoplastic composites having improved flexural strength, impact strength, tensile strength, wear/frictional, electrical resistivity and/or EMI/RFI shielding properties.

### BACKGROUND OF INVENTION

Fiber-reinforced thermoplastic polymer structural components are most commonly manufactured from long fiber thermoplastic (LFT) granulates (pellets), glass mat thermoplastic (GMT) sheets, or pultruded sections. Long fiber-reinforced granulates often include glass fiber bundles encapsulated with a thermoplastic through a cable coating or a pultrusion process. LFT granulates may be injection molded but are more commonly extrusion compression molded in order to preserve fiber length in the finished product. Although the damage to LFT granulates during processing is reduced when extrusion compression molded, some damage still occurs due to shear forces present during plastication.

Polymer components reinforced with fibers may be manufactured using continuous in-line extrusion methods known in the art. Such methods involve the plastication of a polymer in a first extruder, which may be single or twin screw, from which the output is fed to a second process. Fibers are introduced in the polymer melt in the second process either in chopped-segmented form or as continuous strands under a predetermined tension. The fiber-reinforced polymer compound may be fed into an accumulator and then applied automatically or in a separate step to a compression-molding tool wherein the fiber-reinforced polymer compound is shaped as selected for a particular application. Alternatively, the fiber-reinforced polymer compound may be continuously extruded onto a conveyor and sectioned thereupon. The conveyor delivers the sectioned fiber-reinforced polymer compound to a placement assembly that removes the sectioned compound from the conveyor and places the compound upon the compression-molding tool.

In-line extrusion methods used in the art to manufacture fiber-reinforced polymer compounds often damage the fibers during processing thus degrading the performance of the final reinforced composite structural component. Introducing fiber into the polymer melt within the extruder exposes the fiber to an extruder screw therein which rotates to create the polymer melt, mix the melt with the fibers, and move the resulting compound toward an outlet of the extruder. The rotation of the screw exerts shear forces upon the fiber resulting in wearing and eventually breakage of the fiber. The forces within the extruder may also have an adverse effect upon the screw and the interior of the extruder barrel resulting in increased maintenance and cost. Additionally, the fiber may become easily tangled or otherwise fail to be distributed within the extruder, thus preventing a substantially uniform dispersion of the fiber throughout the polymer compound and/or resulting in an inconsistent disposition of individual fiber lengths. Furthermore, the fibers and any additives within the extruder are exposed to the heat of the polymer melt for a substantial amount of time as the screw moves the fiber-reinforced polymer compound the length of the extruder.

Other prior art systems may involve a two-step process on conventional equipment to form finished parts/products. In a first step, the melting and compounding of fillers and plastic occurs to form a consistent plastic melt in processing technologies such as single or twin-screw extruders and Buss kneaders. This melt may then be cooled using a variety of technologies including water baths, slides or belts to cool the material in preparation for pelletization by either strand or die face pelletizers. In a second step, the pellets are dried using vacuum or desiccant dryers in preparation for use in standard injection molding processes to form the plastic melt into a final shape.

As a result, however, current two-step processes used for the manufacture of thermoplastic composites limit the ultimate properties of the finished product due to multiple heat histories during processing. The current process also limits the desired level of cleanliness that can be achieved due to the multi-step approach used in their manufacture, due to the use of water baths during pelletization.

Nevertheless, none of the prior art processes have addressed the issue of incorporating fibers into thermoplastics wherein the resulting composition is extruded and injected molded in a single process wherein the integrity and/or benefits of using long fibers in these plastic materials is maintained due to processing of the material.

### SUMMARY OF THE INVENTION

The present invention provides a process for forming thermoplastic composite materials and articles that include these materials. The process is an in-line compounding process that feeds a thermoplastic resin and at least one filler to an in-line compounding machine to form a thermoplastic composite material that is then injection molded to form an article that includes the thermoplastic composite material. Since the thermoplastic composite material is not pelletized or otherwise processed between formation of the thermoplastic composite material and the injection-molded article, less damage and/or degradation of the filler occurs during processing such that the resultant thermoplastic composite material and/or article has improved flexural, impact, tensile, electrical and/or EMI/RFI shielding properties using less amounts of fillers than prior art materials. In addition, as the thermoplastic composite material is not subjected to ionic and/or airborne contaminates between formation of the thermoplastic composite material and/or the injection-molded article, the resultant materials and/or articles have less impurities in the final materials and/or articles than those formed using prior art processes.

Accordingly, in one aspect, the present invention provides a process for forming thermoplastic composite articles including the steps of feeding a resin and at least one filler into an in-line compounding machine, compounding the resin and at least one filler to form a thermoplastic composite material, passing the thermoplastic composite material to an injection plunger of the in-line compounding machine, and injecting the thermoplastic composite material into a mold using either standard injection or injection-compression techniques; wherein the thermoplastic composite article has at least one improved characteristic as compared to a composite article made from a pelletized thermoplastic composite material and wherein the at least one improved characteristic is selected from flexural strength, impact strength, tensile strength, volume resistivity, surface resistivity, ionic contamination, RFI shielding properties, EMI shielding properties, or a combination that includes at least one of these characteristics. The present invention also provides a thermoplastic composite article made via the process and a thermoplastic composite made during the process.

### BRIEF DESCRIPTION OF THE DRAWINGS

FIG. 1 provides a perspective view of an in-line compounding machine that may be used in the processes of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides thermoplastic composite materials, processes for forming thermoplastic composites materials, and molded articles made from thermoplastic composite materials. The thermoplastic composite materials have improved characteristics as compared to prior art composite materials through the use of a unique compounding process such that fillers added to the thermoplastic materials maintain their structure, thereby increasing the beneficial characteristics of those fillers in the thermoplastic composite and/or any article made that includes these thermoplastic composites.

The present invention involves the use of a compounding approach, termed in-line compounding, for the manufacture of plastic composite parts/and or materials with enhanced properties. In-line compounding eliminates the second heat and/or processing history, thereby resulting in greater fiber lengths and/or less additive degradation. As such, the final molded part is constructed from materials with superior flexural, impact, tensile, electrical (volume and/or surface resistivity), X-ray opacity/detect ability and/or EMI/RFI shielding properties and at equal fiber/additive loadings or even at lower loadings than would otherwise be achieved using a conventional two-step process.

In addition, due to the fact that the thermoplastic composite materials are formed and then processed into an article using injection molding, the thermoplastic composite materials are subjected to fewer outside contaminants as compared to thermoplastic composite materials that are made in conventional two-step processes wherein the thermoplastic composite materials are formed and then pelletized and then used in an injection molding apparatus. As such, there is less opportunity for the thermoplastic composite materials of the present invention to become contaminated with ionic and/or airborne contaminants. As a result, in one embodiment, the present invention permits the creation and manufacture of a new class of ultra clean compounds that have significantly reduced ionic and/or airborne contamination that permit the resulting articles made from these materials to be used in new areas wherein clean compounds are required, such as in electronic packaging. The compositions made according to the processes of the present invention have much lower degrees of contamination, as measured using ion chromatography, such that the resulting level of contamination is on the order of ppm or even ppb in terms of their contamination.

Accordingly, in one aspect of the present invention, the thermoplastic composites of the present invention include a thermoplastic material to which are added one or more fillers. As used herein, a “filler” is any material capable of being added to a thermoplastic resin to impart a characteristic to the resin and includes, but is not limited to, reinforcing fillers such as fibers as well as additives. The thermoplastic material used in the present invention is one that is capable of being processed through an extruder, either a single screw extruder or a double screw extruder or both, and to which one or more fillers may be dispersed, either uniformly or substantially uniformly. Accordingly, any thermoplastic material that may be formed into a composite using an extruder and to which at least one filler may be added and/or dispersed may be used in the present invention. Examples of thermoplastic materials that may be used in the present invention include, but are not limited to, polycarbonate and or copolymers of polycarbonate and siloxane (LEXAN® and LEXAN® EXL resins commercially available from General Electric Company), acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide (NORYL® GTX® resins from General Electric Company), blends of polycarbonate/PET/PBT, polybutylene terephthalate and impact modifier (XENOY® resins commercially available from General Electric Company), polyetherimide ULTEM® resins commercially available from General Electric Company) polyethylene, polyamides, polyphthalamide, phenylene sulfide resins, high impact polystyrene (HIPS), low/high density polyethylene, polypropylene and thermoplastic olefins (TPO), liquid crystal polymers (LCP) and blends and/or combinations thereof.

In addition to the thermoplastic material, the thermoplastic composites of the present invention include at least one filler material. The filler material is selected based upon the selected final properties of the composite material and/or the selected characteristics of an article that includes the thermoplastic composite material. For example, if enhanced surface and volume resistivities of the thermoplastic composite and/or article are desired, the filler may be a material that enhances these characteristics, such as graphite and/or carbon black. If higher specific gravity of the composition is desired, the filler may be a higher specific gravity material such as tungsten.

Accordingly, the present invention may utilize a variety of fillers based upon the selected characteristic and/or characteristics of the thermoplastic composite material and any article made that includes the thermoplastic composite material. In one embodiment, the thermoplastic composite material and any article made that includes the thermoplastic composite material are selected to have improved electromagnetic interference (EMI) and/or radio frequency interference (RFI) shielding properties. In this embodiment, the filler or fillers may be selected from chopped (short) and long carbon fiber, short and long stainless steel fiber, or blends thereof. In addition, these fillers may be used in any thermoplastic material, but are especially beneficial in those thermoplastic composites wherein the thermoplastic material is selected from polycarbonate or copolymers of polycarbonate and siloxane, acrylonitrile-butadiene-styrene, polyphenylene oxide, polyphenylene sulfide, nylon 6, nylon 6,6 nylon 12, polyetherimide, polyethylene terephthalate, polybutylene terephthalate, polyoxymethylene, polystyrene, polypthalamide, or a blend or combination that includes one or more of these thermoplastic materials. As used herein, “short” fibers typically include those fibers having a length, in one embodiment, of 2 mm or less. In another embodiment, “short” fibers include those fibers having a length of 1 mm or less. Conversely, “long” fibers typically include those fibers having a length, in one embodiment, of 2 mm or greater. In another embodiment, “long” fibers include those fibers having a length of 5 mm or greater. In still another embodiment, “long” fibers include those fibers having a length of 10 mm or greater.

In another embodiment, the thermoplastic composite material and any article made that includes the thermoplastic composite material are selected to have reduced levels of ionic contamination, such that the materials have beneficial application in anti-static applications. Examples of fillers that may be used in this embodiment include, but are not limited to, polyamide-polyether permanent antistatic agents such as copolymers of polyamide, polyether and polyolefin as well as tetrabutylphosphonium perfluorobutylsulfonate, or a blend or combination that includes one or more of these anti-static agents. Examples of thermoplastic materials that may be used in these embodiments include, but are not limited to, polycarbonate and blends of polycarbonate including poly(1,4-cyclohexylenedimethylene 1-4,cyclohexanedicarboxylate) (PCCD), polymethyl methacrylate, polycarbonate and acrylonitrile-butadiene-styrene, or a blend or combination that includes one or more of these thermoplastic materials.

In yet another embodiment, the thermoplastic composite material and any article made that includes the thermoplastic composite material are selected to have enhanced surface and/or volume resistivities. Examples of fillers that may be used in this embodiment include, but are not limited to, crystal vein graphite, natural flaky graphite, conductive carbon black, synthetic graphite, carbon powder, carbon nanotubes (single, double or multiwall), carbon nanosheets, or a blend or combination that includes one or more of these fillers. Examples of thermoplastic materials that may be used in this embodiment include, but are not limited to, polyphenylene sulfide, polyethylene (high, linear low and low density), polycarbonate, acrylonitrile-butadiene-styrene, polyphenylene oxide, nylon 6, nylon 6,6 nylon 12, polyetherimide, polyethylene terephthalate, polybutylene terephthalate, polyoxymethylene, polystyrene, liquid crystal polymer(s), polypthalamide, or a blend or combination that includes one or more of these thermoplastic materials.

In still another embodiment, the thermoplastic composite material and any article made that includes the thermoplastic composite material are selected to have improved specific gravity. In this embodiment, the filler may be any filler that is capable of increasing the specific gravity of the material. Examples of fillers that may be used in this embodiment include, but are not limited to, tungsten, stainless steel, bronze, copper, barium sulfate and bismuth, and examples of thermoplastic materials that may be used in this embodiment include, but are not limited to, Nylon 6, Nylon 6,6 thermoplastic polyurethane and polybutylene terephthalate.

In yet another embodiment, the thermoplastic composite material and any article made that includes the thermoplastic composite material are selected to have improved mechanical (flexural and tensile) and impact properties. In this embodiment, the filler may be long glass fiber with the thermoplastic material being nylon 6 or nylon 6,6 or a combination thereof. Alternatively, the filler may be short glass fibers with the thermoplastic material being a polycarbonate.

The degree of improvement of materials made using the methods of the present invention as compared to the prior art methods may be seen from an increase of one or more characteristics even though the same or similar amounts of the individual components are used. Conversely, depending on the resin, the filler and the characteristic, the characteristic may be substantially the same despite less filler being used to achieve that characteristic.

As such, the electrical, volume and/or surface resistivities, the EMI/RFI shielding efficiency in decibels over a range of frequencies, the specific gravity, one or more mechanical properties such as flexural strength and modulus, tensile strength and modulus and the like show increases. In addition, by using the methods of the present invention, the fiber length distributions, as measured using microscopic and optical analysis techniques that permit measurement of fiber length and numerical count of various fibers of certain lengths, show that the materials made by the present invention have better distributions as compared to conventional compounding processes.

As discussed, one of the benefits of the present invention and the use of in-line compounding to produce the thermoplastic composites of the present invention is that the in-line compounding process reduces the amount of breakage and/or destruction of the fillers such that lower loadings of the fillers can be used to achieve the same characteristics as thermoplastic composites made from a conventional two-step process. As such, depending on the thermoplastic material used, the filler used, and/or the selected characteristic or characteristics to be imparted to the thermoplastic composite, the thermoplastic composite materials of the present invention may include up to 95% by weight filler. In one embodiment, one or more fillers that total less than 95% by weight of the total weight of the thermoplastic composite material. In another embodiment one or more fillers that total less than about 50% by weight of the total weight of the thermoplastic composite material. In another embodiment, the thermoplastic composite materials include one or more fillers that total less than about 25% by weight of the total weight of the thermoplastic composite material. In yet another embodiment, the thermoplastic composite materials include one or more fillers that total less than about 15% by weight of the total weight of the thermoplastic composite material. In still another embodiment, the thermoplastic composite materials include one or more fillers that total less than about 10% by weight of the total weight of the thermoplastic composite material. Nevertheless, despite the actual amounts of fillers used, the thermoplastic composite materials, and articles made that include the thermoplastic composite materials, have properties that are, in one or more embodiments, substantially similar to or better than the properties of thermoplastic composite materials made using a two-step process and that include higher levels of loadings of the filler materials due, in part, to longer average fiber lengths that would otherwise be expected from a conventional 2-step process due to avoidance of a second heat history during processing.

In addition to the thermoplastic material and the filler, the thermoplastic composite materials of the present invention may include one or more additives based on the selected properties of the thermoplastic composite material. Examples of additives that may be used include, but are not limited to, heat stabilizers, ultraviolet (UV) stabilizers, antioxidants, release agents, inorganic colorants, organic colorants, flow aids, impact modifiers, wear additives such as silicone or PTFE or a combination of one or more of these additives. In one embodiment, the thermoplastic composite materials of the present invention include one or more additives in an amount of less than or equal to about 10% by weight of the total weight of the thermoplastic composite material. In another embodiment, the thermoplastic composite materials of the present invention include one or more additives in an amount of less than or equal to about 8% by weight of the total weight of the thermoplastic composite material. In yet another embodiment, the thermoplastic composite materials of the present invention include one or more additives in an amount of less than or equal to about 5% by weight of the total weight of the thermoplastic composite material.

The thermoplastic composite materials of the present invention are used to form articles during the in-line compounding process without the need for pelletizing the thermoplastic composite materials after formation. As such, the present invention also includes articles made from these thermoplastic composite materials and processes for making articles that include one or more thermoplastic composite materials.

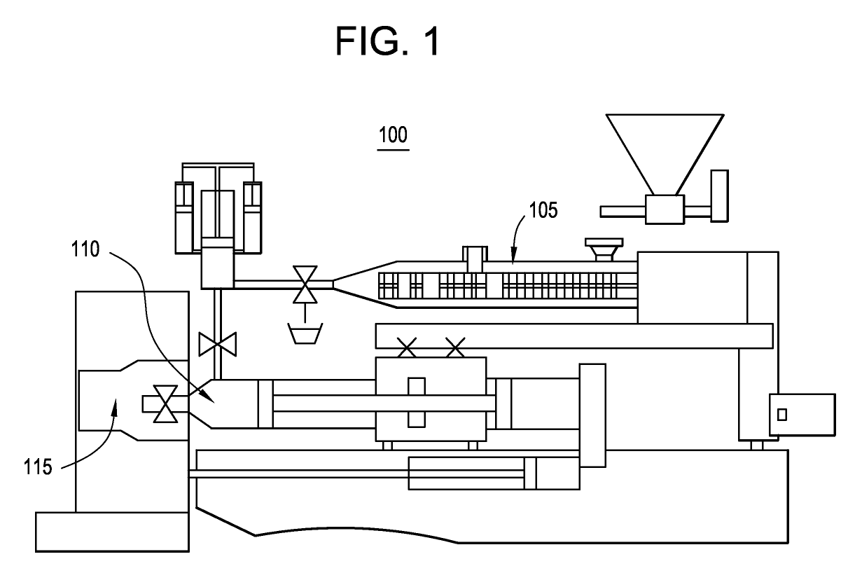

In one embodiment, the present invention includes a process for forming an article using in-line compounding wherein the resin and fillers are added to an in-line compounding machine. An example of an in-line compounding machine 100 that may be used in the present invention may be seen in FIG. 1. In FIG. 1, upon feeding, the mixture of fillers and resin is melted and compounded into a homogeneous melt using a twin-screw compounder 105 that ultimately feeds into a heated shot pot 110. The shot-pot 110 acts as an injection plunger forcing the compounded material into its final shape in the injection-molding portion 115 of the process. The injection-molding portion of the process may also be equipped with a clean booth or flow-box (not shown) to enhance cleanliness of the final molded part. Additionally, the in-line compounding process, in another embodiment, is equipped with injection-compression to facilitate molding of formulations that cannot be injected due to high viscosities using standard injection molding processes.

The present invention is further illustrated by the following non-limiting examples.

### EXAMPLES

### Example 1

In Example 1, the following formulation components (in weight-%) were hand mixed in a plastic bag and introduced to the feedport on an extruder a KM200-1400 injection molding compounder (IMC) available from Krauss Maffei. The extruder was 25 mm in diameter and was a twin-screw co-rotating type machine equipped with 10 barrel sections for an overall L/D ratio of 44/1.

EASTMAN NEOSTAR 19972—50.39

LEXAN 105-111N POLYCARBONATE—28.44

Polymeric Antistat—20.0

GE ANTISTAT—1.0

PEPQ—0.1

Mono Zinc Phosphate—0.07

The temperatures of the extrusion component of the IMC process were set at 420 F across the entire length and the screw speed and throughput were kept constant at 300 rpm and 8 kg/hr respectively.

The melt-compounded mixture was then transferred from the extruder to a 200T molder via a shot pot mechanism set at 420F. Injection molding of the plaques was accomplished on a 200T press portion of the KM200-1400 whereby the mold and melt temperatures were 420 F and 190 F respectively. Injection time was also kept constant at 1.5-1.6 s.

Surface resistivity of the injection molded specimens was carried out according to ASTM D257 and results reported as the average of 5 specimens. Results of the IMC vs. conventional 2-step extrusion and injection molding process are summarized in Table 1. As may be seen from the data, the compositions made according to the present invention show a lower surface resistivity and, therefore, are more conductive than the comparison materials despite the same amount of each component being used.

TABLE 1
Polycarbonate/PBT resin with Polymeric Antistatic agent

| Typical Properties | | 2-step | IMC |
|---|---|---|---|
| Tensile Strength | Mpa | 38.8 | 33.6 |
| Tensile Modulus | Gpa | 1.22 | 1.21 |
| Tensile Elongation | % | 141 | 46 |
| Flexural Strength | MPa | 52 | 44.9 |
| Flexural Modulus | Gpa | 1.28 | 1.24 |
| Izod Impact | kJ/m\hat{ }2 | 124 | 61.3 |
| Surface Resistivity | Ohm/sq | 11.5 | 10 |

### Example 2

In the second example provided, the following formulation components (in weight %) were compounded in the extrusion section of an IMC. The in this example IMC was a KM300-1400 available from Krauss Maffei.

LEXAN® EXL Polycarbonate—87

Stainless steel fiber—10

Polycarbonate/Carbon black (PC-CB) masterbatch—3

The polycarbonate and PC-CB masterbatch were fed at the feedthroat while the stainless steel fiber was fed downstream at barrel section 6. The extruder had the same design features as that provided in example 1. The barrel zone temperatures were set to 550 F across the entire length and the screw speed and feedrate were kept constant at 120 rpm and 13 kg/hr respectively.

The melt-compounded mixture was then transferred from the extruder to a 200T molder via a shot pot mechanism set at 550F. Injection molding of the plaques was accomplished on a 200T press whereby the mold and melt temperatures were 550 F and 190 F respectively. Injection time was also kept constant at 1.5-1.6 s.

Surface resistivity of the injection molded specimens was carried out according to ASTM D257 and results reported as the average of 5 specimens. Results of the IMC vs. conventional 2-step extrusion and injection molding process are summarized in Table 2. Again, as may be seen from the data, the compositions made according to the present invention show a lower surface resistivity and, therefore, are more conductive than the comparison materials despite the same amount of each component being used.

TABLE 2
Polycarbonate resin and stainless steel

| Typical Properties | | 2-step | IMC |
|---|---|---|---|
| Tensile Strength | Mpa | 55.3 | 52.84 |
| Flexural Strength | MPa | 83.29 | 82.7 |
| Flexural Modulus | Gpa | 2.55 | 3.03 |
| Izod Impact | kJ/m\hat{ }2 | 14 | 8.76 |
| Surface Resistivity | Ohm/sq | 2.55 | 1.92 |

### Example 3

In the third example provided, the following formulation components (in weight %) were compounded in the extrusion section of an IMC.

LEXAN 144 Polycarbonate—from 60 to 92%

Chopped Carbon Fiber—from 8 to 40%

The polycarbonate was fed at the feedthroat while the chopped carbon fiber was fed downstream at barrel section 6. The extruder had the same design features as that provided in example 1. The barrel zone temperatures were set to 550 F across the entire length and the screw speed and feedrate were kept constant at 120 rpm and 10 kg/hr respectively.

The melt-compounded mixture was then transferred from the extruder to a molding machine via a shot pot mechanism set at 550F. Injection molding of the plaques was accomplished on a 250T press whereby the mold and melt temperatures were 550 F and 190 F respectively. Injection speed was also kept constant at 1.5-1.6 s.

Surface resistivity of the injection molded specimens was carried out according to ASTM D257 and results reported as the average of 5 specimens. Results of the IMC vs. conventional 2-step extrusion and injection molding process are summarized in Table 3. As the data shows, the materials made using the process of the present invention provided the same or better surface resistivity at the same or lower levels of filler. For example, the sample made using 15% carbon fiber had a lower resistivity than the samples made under the conventional process that included 14% and 16% carbon fiber. This effect was seen at carbon fiber ranges from 8 to 40%

TABLE 3
Polycarbonate and Carbon fiber

Surface Resistivity (ohm/sq)

| % CF | 2-step | IMC |
|---|---|---|
| 8 | | 14.08 |
| 9 | 7.95 | |
| 10 | | 6.2 |
| 12 | | 4.42 |
| 14 | 4.96 | |
| 15 | | 3 |
| 16 | 4.63 | |
| 30 | | 2.84 |
| 31.5 | 3.7 | |
| 40 | | 1.77 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A process for forming thermoplastic composite articles comprising the steps of:
feeding a resin and at least one filler into an in-line compounding machine;
compounding the resin and at least one filler to form a thermoplastic composite material;
passing the thermoplastic composite material to an injection plunger of the in-line compounding machine; and
injecting the thermoplastic composite material into a mold using either an injection molding process or an injection-compression molding process;
wherein the thermoplastic composite article has at least one improved characteristic as compared to a composite article made from a pelletized thermoplastic composite material and wherein the at least one improved characteristic is selected from flexural strength, impact strength, tensile strength, volume resistivity, surface resistivity, ionic cleanliness, RFI shielding properties, EMI shielding properties or a combination that includes at least one of these characteristics.

2. The process of claim 1 wherein the resin is a material selected from acrylonitrile-butadiene-styrene (ABS), polycarbonate, polycarbonate/ABS blend, a copolycarbonate-polyester, acrylic-styrene-acrylonitrile, acrylonitrile-(ethylene-polypropylene diamine modified)-styrene, phenylene ether resins, glass filled blends of polyphenylene oxide and polystyrene, blends of polyphenylene ether/polyamide, blends of polycarbonate/PET/PBT, polybutylene terephthalate and an impact modifier, polyamides (6, 6/6, 11, 12) polyphthalamides, polyphenylene sulfide resins, polyvinyl chloride, high impact polystyrene, low/high density polyethylene, polypropylene and thermoplastic olefins, liquid crystal polymers, polyetherimide and polysulfoneetherimide or a combination that includes at least one of these materials.

3. The process of claim 1, wherein the filler is a material selected from short carbon fibers, long carbon fibers, short stainless steel fibers, long stainless steel fibers, chopped glass fibers, long glass fibers, polyamide-polyether permanent antistatic agents, crystal vein graphite, carbon black, synthetic graphite, carbon powder, tungsten, PTFE, silicone or a combination that includes at least one of these materials.

4. The process of claim 1, further comprising the addition of a performance enhancement additive in an amount of from 0.01 to 20% by weight of the total weight of the thermoplastic composite.

5. The process of claim 4, wherein the performance enhancement additive is selected from heat stabilizers, ultraviolet stabilizers, antioxidants, release agents, inorganic colorants, organic colorants, flow aids, impact modifiers, wear additives such as silicone or PTFE or a combination comprising one or more of the foregoing performance enhancement additives.

6. The process of claim 1, wherein,
the resin comprises polycarbonate,
the filler is selected from stainless steel fiber, carbon fiber, or a combination thereof, and
the improved characteristic is selected from volume resistivity, surface resistivity, or a combination thereof.

7. The process of claim 1, wherein,
the resin comprises polycarbonate,
the performance enhancement additive is selected from polymeric antistatic agents and,
the improved characteristics is selected surface resistivity.

8. The process of claim 1, wherein,
the resin comprises polycarbonate,
the filler is selected from carbon powder, carbon fiber or a combination thereof, and
the improved characteristic is selected from volume resistivity, surface resistivity, or a combination thereof.

9. A thermoplastic composite article comprising a thermoplastic composite material that comprises:
a resin; and
at least one filler;
wherein the resin is a material selected from acrylonitrile-butadiene-styrene (ABS), polycarbonate, polycarbonate/ABS blend, a copolycarbonate-polyester, acrylic-styrene-acrylonitrile, acrylonitrile-(ethylene-polypropylene diamine modified)-styrene, phenylene ether resins, glass filled blends of polyphenylene oxide and polystyrene, blends of polyphenylene ether/polyamide, blends of polycarbonate/PET/PBT, polybutylene terephthalate and an impact modifier, polyamides, polyphthalamides, phenylene sulfide resins, polyvinyl chloride, high impact polystyrene, low/high density polyethylene, polypropylene and thermoplastic olefins, liquid crystal polymers, polysulfoneetherimide and polyetherimide or a combination that includes at least one of these materials;
wherein the filler is a material selected from short carbon fibers, long carbon fibers, short stainless steel fibers, long stainless steel fibers, chopped glass fibers, long glass fibers, polyamide-polyether permanent antistatic agents, crystal vein graphite, carbon black, synthetic graphite, carbon powder, single-wall carbon nanotubes, multi-wall carbon nanotubes, tungsten or a combination that includes at least one of these materials; and
wherein the thermoplastic composite article contains less than about 25% by weight of the filler based on the total weight of the thermoplastic composite material.

10. The article of claim 9, further comprising the addition of a performance enhancement additive in an amount of from 0.01 to 20% by weight of the total weight of the thermoplastic composite.

11. The article of claim 9, wherein the performance enhancement additive is selected from heat stabilizers, ultraviolet stabilizers, antioxidants, release agents, inorganic colorants, organic colorants, flow aids, impact modifiers, wear additives such as silicone or PTFE or a combination comprising one or more of the foregoing performance enhancement additives.

12. The article of claim 9, wherein,
the resin comprises polycarbonate,
the filler is selected from stainless steel fiber, carbon fiber, or a combination thereof, and
the improved characteristic is selected from volume resistivity, surface resistivity, or a combination thereof.

13. The article of claim 9, wherein,
the resin comprises polycarbonate,
the performance enhancement additive is selected from polymeric antistatic agents and,
the improved characteristics is selected surface resisitivity.

14. The article of claim 9, wherein,
the resin comprises polycarbonate,
the filler is selected from carbon powder, carbon fiber or a combination thereof, and
the improved characteristic is selected from volume resistivity, surface resistivity, or a combination thereof.
